(19) United States
(12) Patent Application Publication
(10) Pub. No.: US 2022/0048048 A1
(43) Pub. Date: Feb. 17, 2022

(54) SHOWERHEAD ASSEMBLY WITH MIST NOZZLE

(71) Applicant: ETL, LLC, RENO, NV (US)

(72) Inventor: DAVID HOFMAN, RENO, NV (US)

(73) Assignee: ETL, LLC, RENO, NV (US)

(21) Appl. No.: 16/992,765

(22) Filed: Aug. 13, 2020

(51) Int. Cl. B05B 1/18; B05B 1/30

(52) U.S. Cl. CPC B05B 1/185; B05B 1/3046

(57) ABSTRACT

A water spraying assembly is provided which includes a central conduit, an impeller, and a mist nozzle having a tapered chamber that decreases in cross-sectional area as it narrows into a nozzle outlet sufficiently small so as to reduce the flowing water's pressure as it is transported down the chamber. The impeller includes blades which form channels for receiving water from the central conduit. Further, these channels produce a vortex, rotating the passing water stream. The impeller is directly adjacent to, upstream and in fluid connection with the entrance of the tapered chamber which tapers inwardly until it reaches its smallest measurement at the nozzle outlet. Consequently, the swirling water and the tapered chamber create a low-pressure environment, thereby increasing the water's velocity and force. Due to the high velocity and the outlet's small opening, water is ejected from the outlet as small droplets in a fine mist spray pattern.

### BACKGROUND OF THE INVENTION

The present invention relates to water spraying nozzles. More particularly, the present invention relates to showerhead spray nozzles that produce small droplets of water forming a dispersion of mist.

Spray heads are commercially available in numerous designs and configurations for use in showers, faucets, spas, sprinklers and other personal and industrial systems. Spray heads may be categorized as being either stationary or oscillating and may have fixed or adjustable openings. Stationary spray heads with fixed jets are the simplest constructions consisting essentially of a central conduit connected to one or more spray jets directed to produce a constant pattern. Multi-function spray heads are able to deliver water in different spray patterns such as a fine spray, a coarse spray, a pulsating spray, or even a flood pattern producing a high fluid flow but decreased velocity.

Of course, many other spray patterns may also be provided. For example, the nozzle construction in South Korean Patent Publication No. KR102019011263 discloses multiple misting nozzles that include plates which cause the water to swirl as it exits the nozzle from a tapered chamber having a small outlet. Similarly, the nozzle referenced in German Patent Publication No. DE202010007454 discloses a construction that includes a chamber with a slanted-stepped sidewall which causes the water to swirl within the chamber before emitting droplets in an atomized fashion. Both of these nozzle constructions include a chamber that facilitates in the production of a spinning water stream. However, neither include an impeller which in combination with a chamber, contributes to and intensifies the water stream's spinning effect, and thereby, increases water velocity.

Additionally, U.S. Pat. No. 8,490,895 describes a nozzle construction that uses an inlet which includes an insert with numerous vanes to rotate water within an outlet. This reference discloses a device that is constructed in a manner which produces a spinning effect on the incoming water stream and an outgoing water stream with a spray pattern that is appropriate for mitigating emergency situations, such as a fire or removing hazardous chemicals from one's eyes. This spray pattern is generated by the nozzle outlet's construct which expands in an outwardly manner. Thus, this device lacks a chamber that tapers inwardly into a narrowing nozzle outlet which would ultimately produce high velocity water output in a mist spray fashion.

Furthermore, the showerhead described in U.S. Patent Publication No. 2003/0042331 includes a primary nozzle with spinning propellers in addition to numerous misting nozzles. However, the misting nozzles have neither a tapered cavity nor an impeller.

The aforementioned nozzle constructions achieve spray patterns by implementing features such as an impeller, a tapered chamber, or a small nozzle outlet, but none disclose a device that implements a combination of all of the above.

Misting nozzles commonly include tapered chambers that narrow into a small nozzle outlet. Moreover, impellers are known to be used within showerheads to create a swirling water pattern. Thus, it would be desirable to provide a nozzle construction that includes an impeller, a tapered chamber, and a small nozzle outlet that in combination create a high velocity water stream that emits as a fine mist.

Advantageously, an impeller that does not rotate, but rather includes two or more blades which cause the water to swirl into a downstream tapered chamber would cause the water pattern to increase in velocity. Even more advantageously, the vortex created by this combination of a bladed impeller immediately precedes a narrowing chamber that tapers inwardly to cause the water stream to exit a sufficiently small nozzle outlet so as to create a mist, rather than a spray of water.

These and other more specific advantages of the invention will be apparent to those skilled in the art from the following description taken in conjunction with the drawings.

### SUMMARY OF THE INVENTION

Briefly, in accordance with the invention, an improved water spraying assembly is provided which includes a mist nozzle construction. The mist nozzle water spraying assembly has particular application for use within a showerhead. Accordingly, the preferred mist nozzle water spraying assembly is described as a showerhead assembly. However, the mist nozzle water spraying assembly has application for any water spraying device including faucets, hose nozzles, agricultural spray nozzles, etc.

The preferred showerhead can be relatively traditional in construction including a showerhead housing connected to a water source. Preferably, this showerhead housing includes a longitudinally extending tubular central conduit with a female threaded inlet that threadably engages to a male threaded pipe providing the source of water. The central conduit provides water to the mist nozzle.

In a preferred embodiment, at least one non-mist nozzle is connected to the central conduit and at least one mist nozzle is connected to central conduit. In another preferred embodiment, at least one non-mist nozzle is connected to central conduit and a plurality of mist nozzles are connected to the central conduit.

Specifically, the central conduit has a first end, a body, and a second end. Even more specifically, the central conduit's first end is connected to the female threaded inlet, permitting water to flow from the water source into the central conduit. The central conduit's body conveys such water from the first end to the second end. The second end includes an impeller that is adjacent to the wide inlet of a mist nozzle. The second end receives the water stream from the central conduit's body and transfers it to the impeller.

The impeller is immediately upstream, adjacent to and in fluid connection with a tapered chamber. The tapered chamber may be constructed of various shapes, including a cone shape. However, the preferred chamber has a semi-ellipsoid shape where the flat surface of the semi-ellipsoid forms the chamber's inlet. Particularly, the impeller includes a plurality of spiraling blades which are arranged around the nozzle's longitudinal axis. In a preferred embodiment, the impeller includes two blades. The impeller's blades have a periphery and an interior side so as to form spiral channels by which the water stream received from the base of the impeller can pass through. In the preferred embodiment, the impeller includes two channels.

The water passageways formed by the impeller's channels are arranged so as to cause the water stream to produce a swirling effect or vortex and increase the water's velocity as it travels through the channel downstream into the mist nozzle's tapered chamber. The tapered chamber has a wide proximal end that tapers inwardly into the distal end. The chamber's base is positioned adjacent to the impeller and forms the wide inlet or chamber entrance of the tapered chamber, and the distal end forms the nozzle's outlet which measures to be the smallest diameter of the tapered chamber. The wide inlet has a diameter that measures larger than its nozzle outlet so as to result in a chamber having an inwardly narrowing, tapered shape.

In a preferred embodiment, the impeller has a diameter greater than the wide inlet has a diameter of at least twice the nozzle outlet's diameter so as to result in the tapered chamber having an inwardly tapered shape. In one such embodiment, the wide inlet has a diameter of at least 0.10 inches and the nozzle outlet has a diameter of 0.05 inches or smaller. In an even more preferred embodiment, the wide inlet has a diameter of at least five times greater than the diameter of that of the nozzle outlet's so as to result in the tapered chamber having an inwardly tapered shape.

Given the reduction in fluid pressure that results as water flows through a narrowing cavity, the inwardly tapered shape of the chamber increases the velocity of the water stream traveling through its structure. Additionally, the narrow cone-shaped chamber's distal end, which is also referred to herein as the nozzle outlet, is sufficiently small in diameter so as to create a mist, as opposed to a spray of water when flow is ejected. Preferably, the length of the tapered chamber is 0.20 inches or greater so as to provide greater surface area and, therefore, impetus on the water flow's velocity as it exits the nozzle's small outlet. The combination of the impeller positioned upstream of the nozzle chamber and the nozzle chamber narrowing inwardly to a small outlet, the traveling water stream increases in velocity and is emitted from the small outlet in small droplets in a misting fashion.

Thus, it is the object of the present invention to provide a spray head assembly having an improved mist spray pattern compared to previous showerheads.

Furthermore, it is an additional object of the present invention to provide a spray head assembly having an improved construct so as to generate a high force, high velocity water stream that emits small water droplets in a cone-shaped mist spray pattern.

### BRIEF DESCRIPTION OF THE DRAWINGS

These and other, further and more specific objects and advantages of the invention will be apparent to those skilled in the art from the following detailed description thereof, taken in conjunction with the Drawings, in which:

FIG. 1 is a front view of the showerhead assembly wherein the showerhead includes a plurality of non-mist nozzles and a plurality of mist nozzles;

FIG. 2 is a side cutaway view of the showerhead assembly illustrated in FIG. 1 illustrating the flow of water from a central conduit through the mist nozzle assembly, wherein the showerhead's mist nozzles are expelling water;

FIG. 3 is an exploded side perspective view of the mist nozzle assembly illustrated in FIG. 1 illustrating the mist nozzle and bladed impeller;

FIG. 4 is a side perspective view of the mist nozzle assembly illustrated in FIG. 1 illustrating the mist nozzle and bladed impeller;

FIG. 5 is a perspective left side cutaway view of the mist nozzle assembly illustrated in FIG. 1 illustrating the bladed impeller, narrowing cone shaped chamber, and nozzle outlet of the mist nozzle; and

FIG. 6 is a perspective cutaway view of the mist nozzle assembly in FIG. 1 illustrating the flow of water traveling from the impeller into the inwardly tapered chamber, wherein the water is expelled from the mist nozzle outlet.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

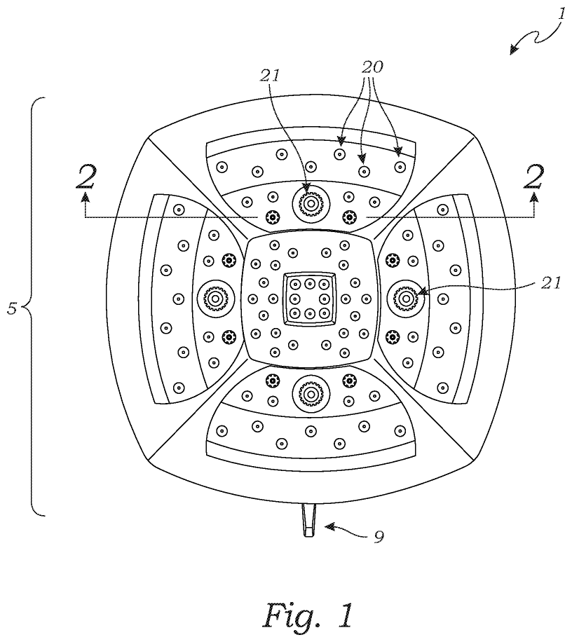

With reference to FIG. 1-6, the mist nozzle 2 of the present invention is illustrated as a showerhead assembly 1 which includes three primary components including: a central conduit 9, an impeller 11, and a tapered chamber 13. In addition, the showerhead assembly 1 may include a face 5 that projects any number of ancillary nozzles 20. The ancillary nozzles 20 may include additional mist nozzles 2 and/or non-mist nozzles 21. As illustrated in FIG. 1, both the mist nozzles 2 and ancillary nozzles 20 are embedded in a showerhead's face 5 and connected to the central conduit 9. Preferably, the showerhead's face 5 includes at least eight mist nozzles 2 and a multitude of non-mist nozzles 21.

The central conduit 9 connects the nozzles to a water source. Preferably, the water source consists of a male threaded pipe which is typically found in a traditional shower stall. The central conduit has a first end, a body, and a second end (not show in drawings). The first end includes an inlet for receiving water and the second end includes an outlet for expelling water into an impeller 11. The central conduit 9 further includes a body for conveying water from the first end's inlet to the second end's outlet. Preferably, the central conduit's body is a longitudinally extending tubular cavity. Even more preferably, the central conduit's inlet includes female threads which threadably engage to the male threaded pipe of the water source.

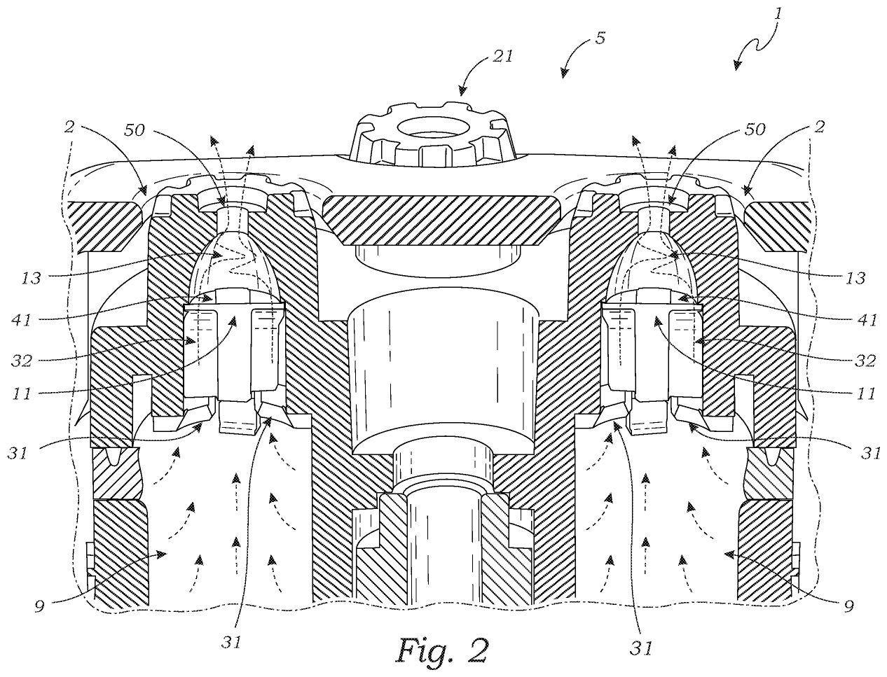

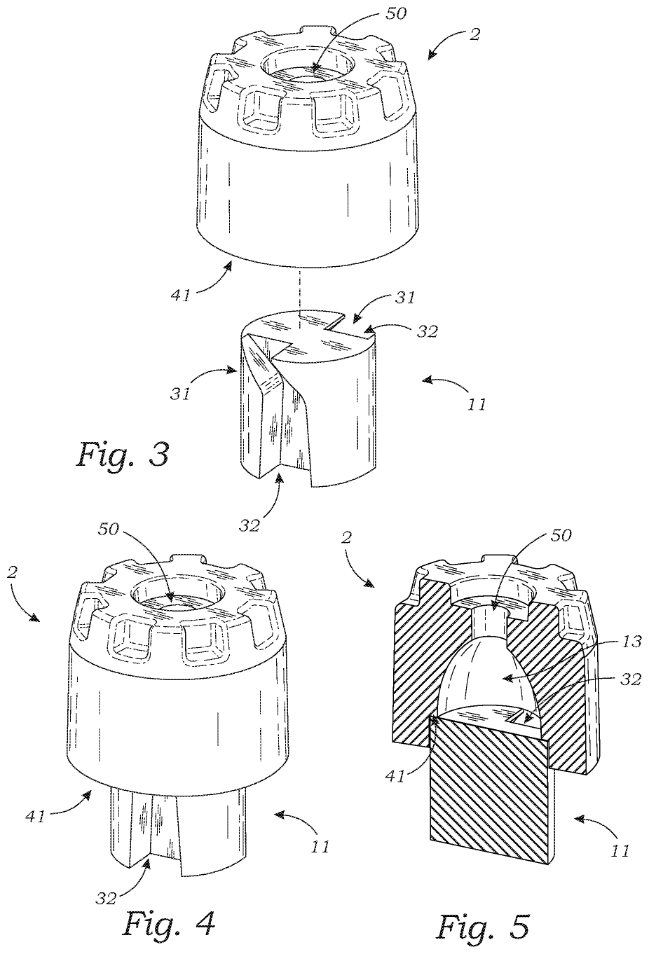

The showerhead assembly 1 further includes an impeller 11 which is located between the central conduit 9 and the mist nozzle 2. As illustrated in FIG. 2, an impeller 11 is located at the central conduit's second end and at the base of the mist nozzle 2. More specifically, the mist nozzle 2 includes a wide inlet 41 in which the impeller 11 is positioned. As best illustrated in FIG. 3, the impeller 11 includes a plurality of blades 31 and is constructed to receive water from the central conduit 9 and rotate the water into a swirling mass before communicating the water to the mist nozzle 2. The impeller's blades 31 are positioned about the mist nozzle's longitudinal axis and have an interior and exterior surface. Additionally, each of the blades 31 are spaced apart from one another to form a plurality of channels 32 which extend radially, at least partially, perpendicular to the nozzle's longitudinal axis.

Preferably, the impeller 11 includes at least two blades 31 which form at least two channels 32. To spin the water, the water stream travels from the base of the impeller 11 through the channels 32 that form on each side of the impeller 11. Preferably, and as best illustrated in FIG. 3 the channels 32 extend perpendicular to the nozzle's longitudinal axis and the blades 31 are angled in such a manner so as to create a spinning effect on the water passing through the channels 32. The channels 32 produce a vortex on the water stream which thereby increases in the water flow's velocity. The spinning water then escapes into the mist nozzle's tapered cone-shaped chamber 13, whereby the narrowing nature of the cavity further intensifies the impetus of the water flow and induces an increase in its velocity.

Preferably, the impeller 11 has a diameter that is the same diameter as the tapered chamber's wide inlet 41 diameter. Alternatively, the impeller 11 may have a diameter which is slightly larger or slightly smaller than that of the tapered chamber's wide inlet 41.

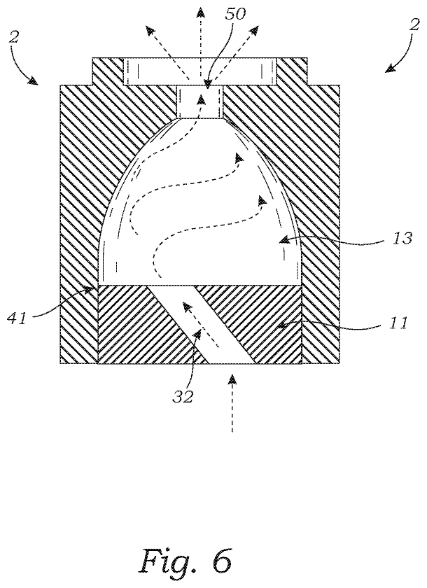

As illustrated in FIGS. 2-6, the tapered chamber 13 includes an entrance, which is also referred to herein as the mist nozzle's wide inlet 41, which is immediately adjacent to and in fluid connection with the impeller 11 that connects to the central conduit 9. Further, the tapered chamber 13 includes an exit which forms the mist nozzle's outlet 50. Importantly, and as illustrated in FIGS. 5 and 6, the tapered chamber 13 tapers inwardly so as to decrease the cross-section through the mist nozzle 2 as water travels downstream from the wide inlet 41 to the nozzle outlet 50. The tapered chamber may have various shapes as can be determined by one skilled in the art. For example, the chamber may be cone-shaped or frusto-conically shaped. However, the preferred chamber 13 has a semi-ellipsoid shape as illustrated in the FIGS. Preferably, the tapered chamber's 13 length is equal to or greater than the diameter of the wide inlet 41. Importantly, as the cross-section within the chamber 13 decreases, the velocity of the water stream increases, causing a reduction in pressure and an enhanced mist spray pattern as water expels out through the small nozzle outlets 50.

Importantly, and as illustrated in FIGS. 2-6, the nozzle outlet 50 is sufficiently small in diameter so as to create a constricted area in which the water can be expelled from at a high pressure and high velocity. The nozzle outlet's 50 diameter represents the tapered chamber's 13 smallest cross section diameter. Preferably, the nozzle outlet's 50 diameter is no more than half the diameter of the tapered chamber's wide inlet 41. For example, preferably the nozzle outlet's 50 diameter is 0.09 inches or smaller and the tapered chamber's wide inlet 41 has a diameter of at least 0.10 inches. In more preferred embodiments, the chamber has an inlet diameter of between 0.12 inch-0.20 inch and an outlet diameter between 0.01 inch-0.09 inch. In a still more preferred embodiment, the impeller has a diameter of approximately 0.16 inch, and the chamber has an inlet diameter of approximately 0.16 inch and an outlet diameter of approximately 0.05 inch.

In other preferred embodiments, the tapered chamber's wide inlet 41 has a diameter that is at least five times greater than that of the mist nozzle outlet 50. Advantageously, the greater difference between the diameter of the nozzle outlet 50 and that of the wide inlet 41 results in a greater increase in water velocity exiting the nozzle. This water's exit velocity is further increased by the impeller inducing a swirling effect in the chamber.

As a result, water is expelled from the small nozzle outlet 50 as small, fine droplets that disperse in a mist pattern. Advantageously, the present invention provides an improved mist nozzle 2 for a shower assembly 1. Specifically, it is the combination of the impeller 11 being upstream of the mist nozzle 2 and water further traveling through a narrowing chamber 13 that tapers inwardly to a small outlet 50 that produces a mist spray which is ejected from the showerhead's nozzle with an increased force and velocity.

The mist nozzle with an impeller and tapered chamber 13 can be incorporated into any shower assembly. While a preferred mist nozzle and showerhead assembly have been illustrated and described, it would be apparent that various modifications of the mist nozzle and showerhead assembly can be made without departing from the spirit and scope of the invention. Accordingly, it is not intended that the invention be limited except by the following claims. Having described my invention in such terms to enable a person skilled in the art to understand the invention, recreate the invention, and practice it, and having identified the presently preferred embodiments thereof,

I claim:

1. A water spraying assembly comprising:
a female threaded inlet threadably engaged to male threaded pipe of water source;
a longitudinally extending central conduit for the passage of water having a first end, a body, and a second end, said central conduit's first end affixed to said female threaded inlet for receiving water, said central conduit's body for conveying such water from said first end to said second end, and said second end forming said central conduit's outlet to expel water;
an impeller positioned within said central conduit at said central conduit's second end; and
a mist nozzle having a tapered chamber that tapers inwardly from a wide inlet to an outlet, said chamber's wide inlet immediately adjacent to, downstream and in fluid connection with said impeller so as to receive water into said chamber which is then expelled from said mist nozzle's outlet.

2. The water spraying assembly of claim 1 wherein said impeller includes a plurality of blades positioned about said mist nozzle's longitudinal axis and having an interior and exterior surface, said blades positioned in such a manner so as to have said blades' interior and exterior surfaces form channels for water passage.

3. The water spraying assembly of claim 2 wherein the water stream from said central conduit enters said impeller through said impeller's channels, said channels and said blades angled so as to produce a vortex and spinning effect on a water stream, causing such water to rotate as it passes through said channels into said tapered chamber.

4. The water spraying assembly of claim 2 wherein said plurality of blades includes two blades forming at least two channels.

5. The water spraying assembly of claim 1 wherein said tapered chamber has a semi-ellipsoid shape.

6. The water spraying assembly of claim 1 wherein said tapered chamber's wide inlet has a diameter that is at least twice the diameter of said nozzle's outlet.

7. The water spraying assembly of claim 1 wherein said tapered chamber's wide inlet has a diameter of at least 0.10 inches to 0.20 inches and said nozzle outlet's diameter is 0.09 inches or smaller.

8. The water spraying assembly of claim 1 wherein said impeller's diameter is equal to or greater than said tapered chamber's wide inlet diameter.

9. The water spraying assembly of claim 1 wherein said impeller's diameter is 0.12 to 0.20 inches and said tapered chamber's entrance is 0.012 inches to 0.20 inches.

10. The water spraying assembly of claim 1 wherein said impeller's length is less than or equal to said tapered chamber's length.

11. The water spraying assembly of claim 1 includes at least one non-mist nozzle connected to said central channel and at least one mist nozzle connected to said central channel.

12. The water spraying assembly of claim 1 includes at least one non-mist nozzle connected to said central channel and a plurality of mist nozzles connected to said central channel.
